(19) United States
(12) Patent Application Publication
(10) Pub. No.: US 2007/0049498 A1
(43) Pub. Date: Mar. 1, 2007

(54) Agricultural compositions which enhance performance of herbicides

(76) Inventors: Mickey R. Brigance, Germantown, TN (US); Greg McManic, Memphis, TN (US)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 11/218,345

(22) Filed: Sep. 1, 2005

(51) Int. Cl. A01N 25/04; A01N 25/16

(52) U.S. Cl. 504/365

(57) ABSTRACT

Agricultural compositions and/or tank mix adjuvants, which exhibit enhanced performance properties such as reduced eye irritation, reduced fish toxicity, and improved compatibility with other tank mixed pesticides and/or adjuvants while maintaining typical pesticidal performance characteristics containing at least one amine ethoxylate and glycerol.

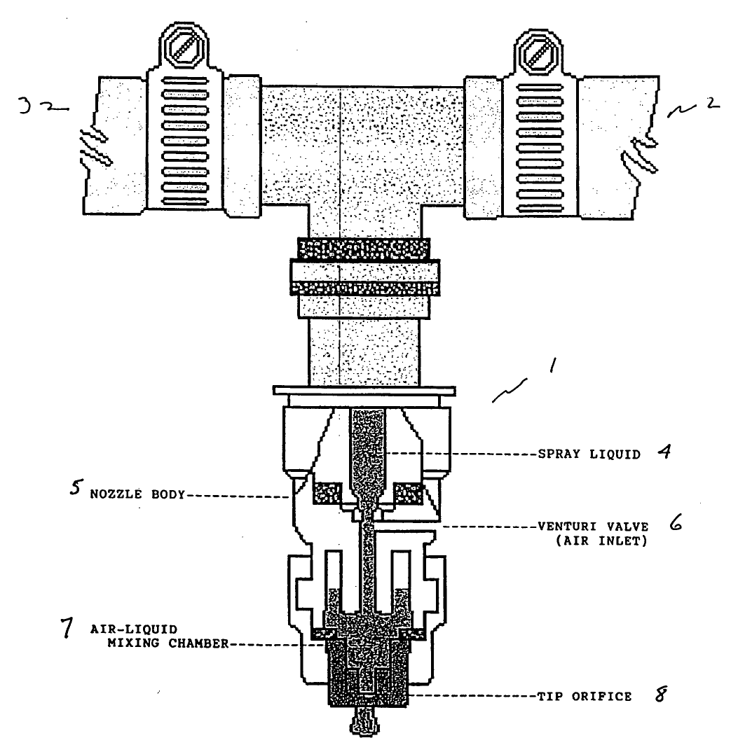

### INTRODUCTION AND BACKGROUND

The present invention relates to agricultural compositions and tank mix adjuvants, which exhibit enhanced performance properties such as reduced toxicity to aquatic species, reduced eye irritation, and improved compatibility with other tank mixed pesticides and/or adjuvants without reducing effectiveness of the primary pesticide. The agricultural compositions of the present invention may be in the form of an aqueous solution, water emulsion, dispersion, or reverse phase emulsions, emulsifiable concentrates (EC) formulations, microemulsifiable concentrates (MEC), and the like. The agricultural compositions of the present invention may be in the form of a tank mix adjuvant or in the form of a finished pesticide formulation containing said adjuvant.

It is well known in agriculture to apply various agrochemicals to growing areas by spraying a mixture, dissolved, emulsified, or dispersed, in an aqueous media. The growing areas may be crop areas in the field, which can be very large, or smaller growing areas such as those in greenhouses. The agrochemicals applied as sprays include fertilizers, micronutrients, herbicides, pesticides and the like. These materials can be applied to the target surfaces including the host crops and/or the soil. The agrochemicals must be applied via a carrier and reach the target surfaces to exert their desired biological effects. As the term is used herein, “pesticide” includes herbicides, insecticides, fungicides, and miticides.

Adjuvants may be in the form of a liquid or dry powder. Adjuvants are available to both the agricultural and nonagricultural markets, and each type of product has its advantages and disadvantages. Adjuvant types include but are not limited to crop oil concentrates, nonionic surfactants, drift control agents, compatibility agents, and water conditioning agents.

It is well recognized by the agricultural industry that it is advantageous to the end-users to be able to formulate agricultural chemicals such as fertilizers, pesticides, and/or adjuvants so that they can be easily mixed with water and applied by means of a spraying apparatus to a target area.

It also is well recognized by the agricultural industry that it is advantageous to the end-user to be able to mix two or three or more pesticides into the spray mixture without causing mixing issues such as flocculation, thickening of the spray mixture, and precipitation of the active pesticide into a residue which is difficult to spray.

It also is well recognized by the agricultural industry that it is advantageous to the end-user to be able to spray an agricultural spray mixture without causing environmental harm from the spray mixture. Worker exposure and toxicity to aquatic species are particularly important.

Pesticide formulation components are also selected to ensure that the pesticide composition will disperse or emulsify evenly in a tank mix at the point of application. They also have a purpose of ensuring optimum delivery of the tank mix preparation to the targeted pest or substrate. Sometimes the surfactants incorporated in pesticide formulations are not sufficient to fully ensure stable tank mixes when such tank mixes contain multiple components. Similarly, it may be necessary to add adjuvants to the tank mix for full stability. Surfactants are the most important and widely used components as adjuvants. Surfactants may affect many properties of the formulation such as solubility, volatility, specific gravity, corrosiveness, efficacy, and freezing and flash points. It is widely known that adding surfactant-based adjuvants to the tank mix will realize the desired stabilization and application of the spray mix. Adjuvants also may aid in potentiating the activity of many pesticides and there are many adjuvant formulations that have been developed for this purpose. Surfactants are nearly always components of these adjuvants ranging from minor components to the sole component.

One class of pesticides that has found success is, for example, N-phosphonomethylglycine (glyphosate) formulations containing polyoxyalkylene aliphatic amines such as, for example, ethoxylated tallow amine. While polyoxyalkylene aliphatic amine-based adjuvants have excellent properties of enhancing the efficacy of phytotoxicants such as glyphosate, they unfortunately are severe eye irritants and must be used with a high degree of caution by agricultural applicators. Reducing or eliminating the eye irritancy of the polyoxyalkylene aliphatic amine adjuvants used with pesticides, without reducing the efficacy of the pesticidal compositions containing the surfactants, is a highly desirable end. The protection of the applicator and personnel preparing the surfactant and pesticidal compositions from eye damage is of paramount importance. Reducing the eye irritancy of the adjuvants and pesticidal compositions containing the adjuvant, increases the use that can be made of such products while lessening the possibility of injury to personnel handling and using them.

Various salts of glyphosate, methods for preparing salts of glyphosate, formulations of glyphosate or its salts and methods of use of glyphosate or its salts for killing and controlling weeds and other plants are disclosed in U.S. Pat. No. 4,507,250 to Bakel, U.S. Pat. No. 4,481,026 to Prisbylla, U.S. Pat. No. 4,405,531 to Franz, U.S. Pat. No. 4,315,765 to Large, U.S. Pat. No. 4,140,513 to Prill, U.S. Pat. No. 3,977,860 to Franz, U.S. Pat. No. 3,853,530 to Franz, and U.S. Pat. No. 3,799,758 to Franz. Finished glyphosate formulations may be in the form of various aqueous salts such as but not limited to the K-salt, IPA salt, NH₄ salt and MEA salt. It is well known that a tallow amine ethoxylate is used as a surfactant for glyphosate in a range from (1.75:1.0) to (6.0:1.0) parts glyphosate acid equivalent to tallow amine surfactant in finished glyphosate formulations. IPA salt formulations are most common and have typicality used an ethoxylated tallow amine with a degree of ethoxylation from 10-20 moles.

K-salt formulations of glyphosate are newer to the industry and deliver more glyphosate salt per unit of volume than the IPA salt formulations do. However, there are several problems in using the K-salt of glyphosate as the primary or sole source of glyphosate in concentrated formulations which are typically considered commercial. Tallow amine ethoxylates with an average ethoxylate of 10-20 moles are not soluble in the K-salt. In order to have compatibility with the K-salt, a lower ethoxylation level of the tallow amine must be used.

As disclosed in U.S. Pat. No. 5,668,085, Forbes et al., it has been found desirable to use a somewhat less hydrophilic alkylamine surfactant, such as one having less than about 10 moles of ethylene oxide, for example polyoxyethylene (2) cocoamine or polyoxyethylene (5) tallow amine. That patent discloses illustrative aqueous compositions comprising such a surfactant together with the IPA, ammonium or potassium salts of glyphosate. Tallow amine ethoxylates in the 2-5-mole range are soluble in both the K-salt and NH₄ salts of glyphosate. Functional rates of glyphosate acid equivalent to surfactant as stated above require high levels of amine ethoxylate to function properly. The resulting increasing toxicity to the eye is ameliorated which the Forbes patent teaches by using acid entities such as phosphate ester based surfactants. The patent does not address compatibility issues with anionic components in the spray mix nor does this patent address increased fish toxicity due to the high levels of the highly cationic amine surfactant.

Tallow amine and other amine based ethoxylate surfactants have cationic charges that can react with other oppositely charged surfactants or pesticides. The less ethoxylation that is attached to the tallow or other amine, the stronger is the cationic charge on the surfactant. Tallow amine and other amine based ethoxylates also pose an increasingly negative effect on toxicity to eyes and aquatic life. The greater the cationic charge, the worst is the toxicity on the aquatic life and eyes.

One method to reduce the toxicity and incompatibility is to reduce the amount of the tallow amine or other amine based ethoxylate such as a 5 mole tallow amine ethoxylate in the formulation. This reduces the antagonism caused by mixing two or three or more pesticides which contain anionic components as well as reducing the toxicity potential to the eyes and to aquatic life. Reducing the tallow amine ethoxylate level in the formulation however, also reduces the performance of the pesticide.

One type of tallow amine surfactant for glyphosate is disclosed in U.S. Pat. Nos. 6,645,913 and 6,432,878. These patents describe the use of tricarboxylic acids to reduce the eye toxicity of the tallow amine ethoxylates used in the glyphosate formulations.

Yet another type of tallow amine ethoxylate surfactant for glyphosate is disclosed in U.S. Pat. No. 5,703,015. This patent describes the use of phosphate esters to reduce the eye toxicity of the tallow amine ethoxylate.

### SUMMARY OF THE INVENTION

The present invention involves both agricultural compositions and tank mix adjuvants, which exhibit enhanced performance properties such as reduced aquatic toxicity, reduced eye irritation, and improved compatibility with other tank mix pesticides and/or adjuvants while maintaining acceptable herbicidal performance characteristics of the pesticide when mixed in a spray tank and applied to a desired substrate, which can be a plant, soil or crop.

According to one aspect of the present invention, there is provided a method for enhancing the agricultural spray mixture while reducing the toxicity to aquatic species. The homogeneous, adjuvant formula of the present invention significantly reduces the amount of amino ethoxylate, particularly tallow amine ethoxylate, and replaces it with glycerol and unexpectedly maintains equal herbicide performance on the desired pest.

In another aspect of the invention, there is provided a homogeneous composition where the applicator is able to mix two or three or more pesticides into the spray mixture without causing mixing issues such as flocculation, thickening of the spray mixture, and/or precipitation of the active pesticide resulting in a difficult to spray mixture. Reducing the amount of tallow amine or other amine based ethoxylate and replacing it with glycerol reduces antagonism caused by mixing two or three or more pesticide formulations containing anionic components and surprisingly maintains equal herbicidal performance on the desired pest.

The present invention is directed to an adjuvant composition for pesticide formulations which exhibits reduced eye irritancy, reduced aquatic toxicity and increased compatibility with other pesticide formulations containing anionic components. The adjuvant composition according to the invention is comprised of a polyoxyalkylene aliphatic amine containing at least about 2 moles of an alkylene oxide group. The adjuvants according to the invention also contain a mixture of polyhydric alcohols and, optionally, a defoamer. The mixture of polyhydric alcohols is comprised of a trihydric alcohol, such as glycerol with alternately one or more diols, e.g. alkylene diols such as ethylene glycol, diethylene glycol, and propylene glycol. The adjuvant according to the invention is particularly useful in N-phosphonomethylglycine (glyphosate) herbicidal formulations. The invention is also directed to a method of killing or controlling weeds, which comprises contacting the weeds with a herbicidally effective amount of the composition according to the invention.

### BRIEF DESCRIPTION OF DRAWING

The accompanying drawing illustrates the type of spray nozzle that can be used for purposes of the invention.

### DETAILED DESCRIPTION OF INVENTION

The term “pesticide” as used herein includes chemicals and microbial agents used as active ingredients of products for control of crop and lawn pests and diseases, animal ectoparasites, and other pests in public health. The term also includes plant growth regulators, pest repellants, synergists, herbicide safeners (which reduce the phytotoxicity of herbicides to crop plants) and preservatives.

In one aspect of the invention, the agricultural composition that forms an enhanced activity when added to the spray tank is an adjuvant that contains at least one amine ethoxylate surfactant and a glycerol. The adjuvant also may contain other functional agents including but not limited to defoamers, humectants, sequestering agents, deposition agents, and the like. The adjuvant composition is normally supplied as a concentrate that is then diluted when ready for spraying with the agrochemical. The adjuvant may also be added directly into the active pesticide formulation.

According to another aspect of the invention, the adjuvant composition contains at least one amine ethoxylate surfactant and a trihydric alcohol plus at least one diol; e.g. alkylene diol such as ethylene glycol, diethylene glycol, propylene glycol and the like. The preferred trihydric alcohols are aliphatic or alkane triols such as glycerol, CH₂OHCHOHCH₂OH.

As mentioned above, the present invention relates to agricultural compositions and tank mix adjuvants, which exhibit enhanced performance properties such as reduced aquatic toxicity, reduced eye irritation and increased compatibility with other tank mix pesticides without reducing the pesticidal effectiveness of the primary pesticide in the agricultural composition. The agricultural composition that demonstrates enhanced properties when added to the spray tank is an adjuvant that preferably contains at least one amine ethoxylate surfactant and a trihydric alcohol such as glycerol. The pH of the spray adjuvants and the pH of the pesticide formulation containing the spray adjuvant is from about 2 to about 7.

The adjuvant composition of the present invention preferably comprises a polyoxyalkylene aliphatic amine having at least about 2 moles of an alkylene group and glycerol. The adjuvant composition of this invention exhibits eye irritancy lower than the eye irritancy of the polyoxyalkylene aliphatic amine surfactant itself.

The polyoxyalkylene aliphatic amines according to the invention are compounds of the formula: 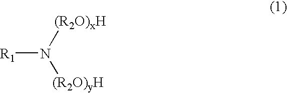
wherein R₁ is straight or branched alkyl or alkenyl having from 6 to 22 carbon atoms, R₂ is an alkylene group having from 2 to 4 carbon atoms, x and y are numbers such that x+y has an average value of from about 2 to about 50.

The polyoxyalkylene aliphatic amines are present in the adjuvant in an amount sufficient to increase the efficacy of the pesticide or plant growth regulator with which it is formulated. Such an amount of the polyoxyalkylene aliphatic amines normally causes eye irritation to users of formulations containing a pesticide or plant growth regulator, especially when such formulations are applied by spraying.

Preferred polyoxyalkylene aliphatic amines are ethoxylated tallow amines having a degree of ethoxylation of about 20. In reference to compounds having the formula 1, such amines are those wherein R₁ is a mixture of saturated or unsaturated carbon chains having from about 8 to about 22 carbon atoms, R₂ is an ethylene group and x+y has an average value of about 20. The typical amount of polyoxyalkylene aliphatic amine in the adjuvant according to the invention can range from about 1% to about 85% by weight of the adjuvant with the preferred amount typically ranging from about 10% to about 30% by weight of the adjuvant and a most preferred amount typically ranging from 13% to 20% by weight of the adjuvant composition.

The adjuvants according to the invention also contain glycerol and optionally a mixture of polyhydric alcohols and, optionally, a defoamer. A polyhydric alcohol or polyol is a compound having at least 2 alcohol functionalities. The mixture of polyhydric alcohols is preferably comprised of at least one trihydric alcohol, preferably glycerol and optionally a glycol, preferably an alkylene glycol such as ethylene glycol, diethylene glycol, propylene glycol or a combination thereof. While the mixture of polyhydric alcohols can contain any combination of polyols in any relative amount, it is preferably comprised of a combination of glycerol, ethylene glycol and propylene glycol present in an amount of from about 10% to about 70% by weight of the adjuvant. The relative amounts of the various polyhydric alcohols within the mixture will vary according to the nature of the pesticide and the end use of the pesticidal formulation and will typically be ascertainable by those skilled in the art. The optimum amount of each component in the adjuvant depends on variables such as the identity of the surfactant component, the identity of the pesticide, the type of application of the pesticide composition, the type of storage and transportation of the surfactant and pesticide compositions, the conditions of use of the pesticidal compositions, etc. and is readily determinable by those skilled in the art. The adjuvant of the present invention can contain optional components to improve the water solubility of the surfactant composition and suppress gel formation. The need for such components will depend upon several factors, especially the identity of the surfactants comprising the composition.

When used as an adjuvant with glyphosate, the adjuvant according to the invention is typically used at the level of from about 120 grams to about 180 grams of adjuvant per liter of an aqueous glyphosate solution containing about 480 grams of the isopropyl amine salt of phosphonomethyl glycine or equivalent rates of other glyphosate salts.

For example, the range can be 0.25 to 0.375 grams of adjuvant per gram of glyphosate.

The adjuvants according to the invention can be combined with a pesticidally effective amount of any type of pesticide to form a pesticidal composition. Examples of pesticides with which the adjuvants according to the invention can be formulated include, but are not limited to, glyphosate and acifluorfen (5-(2-chloro-4-(trifluoromethyl)phenoxy)-2-nitrobenzoic acid), chloramben (3-amino-2,5-dichlorobenzoic acid), 2,4-D ((2,4-dichlorophenoxy) acetic acid), endothal (7-oxabicyclo(2.2.1)heptane-2,3-dicarboxylic acid), mecoprop (2-(2-methyl-4-chlorophenoxy)propionic acid), picloram (4-amino-3,5,6-trichloropyridine-2-carboxyl acid), 2,4,5-T((2,4,5-trichlorophenoxy)acetic acid), benzac (2,3,6-trichlorobenzoic acid), dicamba (3,6-dichloro-o-anisic acid), MCPA (4-chloro-o-tolyloxyacetic acid), dalapon (2,2-dichloropropionic acid), dichlorprop (2-(2,4-dichlorophenoxy)propionic acid), MCPB (4-(4-chloro-o-tolyloxy)butyric acid), bialaphos (L-2-amino-4-((hydroxy)(methyl) phosphinoyl) butyryl-L-alanyl-L-alanine), glufosinate ((3-amino-3-carboxypropyl)methylphosphinate), imazethapyr (2-[4,5-dihydro-4-methyl-4-(1-methylethyl)-5-oxo-1H-imidazol-2-yl]-5-ethyl-3-pyridinecarboxylic acid), imazaquin (2-[4,5-dihydro-4-methyl-4-(1-methylethyl)-5-oxo-1H-imidazol-2-yl]-3-quinolinecarboxylic acid), mixtures thereof and the like. Preferred results, however, are obtained with the herbicide glyphosate whose activity is derived from N-phosphonomethylglycine. Glyphosate is normally formulated from water soluble salts thereof. The use of glyphosate and its derivatives as herbicides is disclosed in U.S. Pat. No. 3,853,530, the entire contents of which are incorporated herein by reference.

The adjuvants of the present invention are especially useful in the preparation of pesticidal compositions designed to be delivered by spraying, particularly sprayable herbicidal compositions. When combined with a pesticide, the adjuvants according to the invention can be made into a concentrate, which can subsequently be diluted with water to form an aqueous pesticidal composition ready for use by spraying.

Since glyphosate in acid form has limited water solubility (about 1.2%) the water-soluble salts of glyphosate are normally used for most applications. Among the water soluble salts of glyphosate are the trimethylsulfonium salt, the ammonium salt, the isopropyl amine salt, and the alkali metal salts, such as sodium and potassium. These compounds due to their solubility in water are the agriculturally acceptable glyphosate-containing compounds generally used in commerce. The relative amounts of herbicide, water and surfactant in the aqueous herbicidal compositions of this invention will vary depending upon many factors including but not limited to the identity and properties of the herbicide, method of application, locus to which the herbicide is applied, etc.

The accompanying drawing illustrates a typical nozzle that can be used to apply the formulations described herein.

One useful way to apply the formulations of this invention is by using air induction nozzles. The key characteristic of sprays produced from air induction nozzles is the entrapment of air (air bubbles) in the spray droplets. The air bubbles affect droplet size and droplet velocity and therefore droplet impaction and spray retention on the target surfaces. The air bubbles in the spray droplet tend to reduce the density of the droplet and improve droplet impaction and spray retention on target surfaces compared to droplets of similar size that do not contain air.

Nozzle Types

Suitable nozzles for purposes of the present invention include the Hardi InJet 11001 nozzles manufactured by Hardi International, Davenport, Iowa 528056. Air induction nozzles are known in the art as shown for example in U.S. Pat. No. 5,765,761, U.S. Pat. No. 4,004,733 and U.S. Pat. No. 5,975,425.

The only type of air induction nozzle used in standard agricultural practices can be classified as containing a venturi device, which is designed into the nozzle body. These are small inlets in the side of the body of the nozzle that allows air to be injected into the stream of liquid passing over the inlet. The air entrapped in the liquid lowers the spray pressure within the nozzle body, and also air is entrapped within the spray solution, which lowers the density of the sprayed solution. The result of the entrapped air improves droplet impaction and spray retention on target surfaces. Air induction nozzles minimize fine droplets. Hence, undesired drift is reduced.

The accompanying drawing shows a schematic cross sectional view of a typical nozzle (1) of the air induction type showing feed lines 2, 3 for feeding components of the spray such as adjuvant and agrochemical, respectively. The spray liquid 4 then passes through nozzle body 5. Air inlet 6 introduces air to create a venturi jet effect. The air-liquid mixture is mixed in the mixing chamber 7 of the valve body. The spray exits at the tip orifice 8 to contact the intended plant, crop or soil with the desired agrochemical composition.

Formulations containing a herbicide such as glyphosate and the compositions according to the invention are effective at killing and/or controlling the growth of weeds. The following examples are meant to illustrate but not to limit the invention.

### EXAMPLE 1

Adjuvant Composition of AX-0444

| | % Weight |
|---|---|
| AGNIQUE TAM 5 .RTM. | 14.0 |
| Glycerine | 58.0 |
| AGNIQUE .RTM. DF 6889 Defoamer | 0.1 |
| Propylene glycol | 9.2 |
| Water | 18.7 |

AGNIQUE TAM 5 .RTM. is tallow amine ethoxylated with an average of 5 moles of ethylene oxide, a trademark product of Cognis Corporation, Gulph Mills, PA 19406.
AGNIQUE .RTM. OF 6889 Defoamer is a silicone emulsion, a trademark product of Cognis Corporation, Gulph Mills, PA 19406.

The following data shows the effect on weed kill of various formulations on specific weed populations. AX-0444 is described in the above invention.

| Pest Type | | | | | | | | W Weed | W Weed | W Weed | W Weed | W Weed |
|---|---|---|---|---|---|---|---|---|---|---|---|---|
| Pest Code | | | | | | | | SORHA | SORHA | SORHA | SIDSP | SIDSP |
| Pest Name | | | | | | | | Johnson grass | Johnson grass | Johnson grass | Teaweed | Teaweed |
| Crop Code | | | | | | | | | | | | |
| BBCH Scale | | | | | | | | | | | | |
| Crop Name | | | | | | | | | | | | |
| Rating Date | | | | | | | | 23-Jul-04 | 30-Jul-04 | 13-Aug-04 | 23-Jul-04 | 30-Jul-04 |
| Rating Data Type | | | | | | | | CONTRO | CONTRO | CONTRO | CONTRO | CONTRO |
| Rating Unit | | | | | | | | % | % | % | % | % |
| Days After Last Applic. | | | | | | | | 7 | 14 | 28 | 7 | 14 |
| Trt-Eval Interval | | | | | | | | 7 DA-A | 14 DA-A | 28 DA-A | 7 DA-A | 14 DA-A |
| Trt | | Treatment | Form | Form | | Rate | Appl | 2 | 7 | 12 | 3 | 8 |
| No. | Type | Name | Conc | Type | Rate | Unit | Code | | | | | |
| 1 | HERB | Glystar Plus | 4 | SL | 24 | fl oz/a | A | 96 ab | 97 a | 98 a | 76 ab | 80 a |
| 2 | HERB | Roundup | 5.5 | SL | 16.5 | fl oz/a | A | 97 ab | 97 a | 98 ab | 78 ab | 80 a |
| | | WeatherMax | | | | | | | | | | |
| 3 | HERB | AX-0444 | 5.5 | SL | 16.5 | fl oz/a | A | 97 A | 97 a | 98 ab | 74 ab | 79 a |

| | | | | | |
|---|---|---|---|---|---|
| LSD (P = .10) | 1.1 | 0.0 | 1.4 | 6.5 | 5.2 |
| CV | 0.92 | 0.0 | 1.2 | 7.11 | 5.4 |
| Replicate F | 5.727 | 0.000 | 1.070 | 1.569 | 1.621 |
| Replicate Prob(F) | 0.0050 | 1.0000 | 0.3831 | 0.2265 | 0.2145 |
| Treatment F | 1.000 | 0.000 | 0.930 | 1.030 | 0.120 |
| Treatment F Prob(F) | 0.4586 | 1.0000 | 0.5041 | 0.4401 | 0.9961 |

| Pest Type | | | | | | | | W Weed | W Weed | W Weed | W Weed | W Weed | W Weed |
|---|---|---|---|---|---|---|---|---|---|---|---|---|---|
| Pest Code | | | | | | | | SIDSP | SEBEX | SEBEX | SEBEX | ABUTH | ABUTH |
| Pest Name | | | | | | | | Teaweed | Coffeebean | Coffeebean | Coffeebean | Velvetleaf | Velvetleaf |
| Crop Code | | | | | | | | | | | | | |
| BBCH Scale | | | | | | | | | | | | | |
| Crop Name | | | | | | | | | | | | | |
| Rating Date | | | | | | | | 13-Aug-04 | 23-Jul-04 | 30-Jul-04 | 13-Aug-04 | 23-Jul-04 | 30-Jul-04 |
| Rating Data Type | | | | | | | | CONTRO | CONTRO | CONTRO | CONTRO | CONTRO | CONTRO |
| Rating Unit | | | | | | | | % | % | % | % | % | % |
| Day 3 After Last Applic. | | | | | | | | 28 | 7 | 14 | 28 | 7 | 14 |
| Trt-Eval Interval | | | | | | | | 28 DA-A | 7 DA-A | 14 DA-A | 28 DA-A | 7 DA-A | 14 DA-A |
| Trt | | Treatment | Form | Form | | Rate | Appl | 13 | 4 | 9 | 14 | 5 | 10 |
| No. | Type | Name | Conc | Type | Rate | Unit | Code | | | | | | |
| 1 | HERB | Glystar Plus | 4 | SL | 24 | fl oz/a | A | 75 a | 68 ab | 76 abc | 71 a | 71 a | 76 a |
| 2 | HERB | Roundup | 5.5 | SL | 16.5 | fl oz/a | A | 75 a | 71 a | 79 a | 73 a | 71 ab | 73 ab |
| | | WeatherMax | | | | | | | | | | | |
| 3 | HERB | AX-0444 | 5.5 | SL | 16.5 | fl oz/a | A | 72 a | 68 ab | 74 c | 71 a | 69 abc | 74 ab |

| | | | | | | |
|---|---|---|---|---|---|---|
| LSD (P = .10) | 6.4 | 3.4 | 2.8 | 6.8 | 4.8 | 5.6 |
| CV | 7.18 | 4.21 | 3.06 | 8.74 | 5.72 | 6.47 |
| Replicate F | 2.095 | 1.837 | 1.874 | 4.982 | 1.966 | 10.805 |
| Replicate Prob(F) | 0.1314 | 0.1714 | 0.1649 | 0.0091 | 0.1500 | 0.0002 |
| Treatment F | 0.211 | 1.718 | 7.951 | 13.811 | 1.271 | 3.985 |
| Treatment Prob(F) | 0.9789 | 0.1589 | 0.0001 | 0.0001 | 0.3115 | 0.0064 |

| Pest Type | | | | | | | | W Weed |
|---|---|---|---|---|---|---|---|---|
| Pest Code | | | | | | | | ABUTH |
| Pest Name | | | | | | | | Velvetleaf |
| Crop Code | | | | | | | | |
| BBCH Scale | | | | | | | | |
| Crop Name | | | | | | | | |
| Rating Date | | | | | | | | 13-Aug-04 |
| Rating Data Type | | | | | | | | CONTRO |
| Rating Unit | | | | | | | | % |
| Day After Last Applic. | | | | | | | | 28 |
| Trt-Eval Interval | | | | | | | | 28 DA-A |
| Trt | | Treatment | Form | Form | | Rate | Appl | 15 |
| No. | Type | Name | Conc | Type | Rate | Unit | Code | |
| 1 | HERB | Glystar Plus | 4 | SL | 24 | fl oz/a | A | 69 abc |
| 2 | HERB | Roundup | 5.5 | SL | 16.5 | fl oz/a | A | 70 ab |
| | | WeatherMax | | | | | | |
| 3 | HERB | AX-0444 | 5.5 | SL | 16.5 | fl oz/a | A | 68 a |

| | |
|---|---|
| LSD (P = .10) | 6.5 |
| CV | 8.01 |
| Replicate F | 9.893 |
| Replicate Prob(F) | 0.0003 |
| Treatment F | 2.400 |
| Treatment Prob(F) | 0.0569 |

As described herein the adjuvants of the present invention additionally can contain surfactants, emulsifiers or other tank mix performance additives such as a drift reduction products, compatibility agents, stickers etc. The essential component of the invention is an adjuvant containing at least one amine ethoxylate and glycerol.

The adjuvant composition of the present invention is a combination of at least one amine ethoxylate (and may also contain other nonionic, anionic surfactants, cationic surfactants) and glycerol.

Further variations and modifications of the foregoing will be apparent to those skilled in the art and are intended to be encompassed by the claims appended hereto.

We claim:

1. A method for enhancing the performance of an agrochemical onto an agricultural substrate comprising:
applying to said agricultural substrate a sufficient amount of an adjuvant-containing composition in the form of a spray mixture comprising at least one amine ethoxylate, glycerol and an agrochemical.

2. A method for treating an agricultural substrate comprising:
contacting said substrate with an agrochemical composition comprising an agrochemical and an amine ethoxylate and glycerol in a dilute aqueous solution and by spraying said composition onto said substrate using a nozzle and/or drift reduction nozzle.

3. The method of claim 1, wherein the spray additionally contains a tank mix surfactant.

4. The method according to claim 1, wherein the spray mixture has a broad compatibility in the presence of other adjuvants and/or other pesticides.

5. The method according to claim 1, wherein the pH of the spray mixture is from about 2 to about 7.

6. The method according to claim 1, wherein said spray mixture further contains a defoamer.

7. An adjuvant composition comprising:
(a) polyoxyalkylene aliphatic amine; and
(b) a mixture of glycerol and optionally another polyhydric alcohol.

8. The adjuvant of claim 7, wherein the polyoxyalkylene aliphatic amine has the formula: 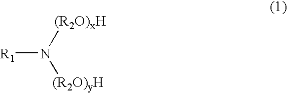
wherein R₁ is straight or branched alkyl or alkenyl having from 6 to 22 carbon atoms, R₂ is an alkylene group having from 2 to 4 carbon atoms, x and y are numbers such that x+y has an average value of from about 2 to about 50.

9. The adjuvant of claim 7, wherein the polyoxyalkylene aliphatic amine is ethoxylated tallow amine having an average degree of ethoxylation of from about 2 to about 50.

10. The adjuvant of claim 7, wherein the average degree of ethoxylation is about 5.

11. The adjuvant of claim 7, wherein the mixture of polyhydric alcohols is comprised of glycerol and optionally at least one of ethylene glycol, diethylene glycol and propylene glycol.

12. The adjuvant of claim 7, wherein the amount of the glycerol is from about 1% to about 70% by weight of the adjuvant.

13. An adjuvant composition comprising (a) an ethoxylated tallow amine having an average degree of ethoxylation of from about 2 to about 50; (b) a mixture comprised of glycerol and optionally at least one of ethylene glycol, diethylene glycol and propylene glycol.

14. The adjuvant of claim 13, wherein the average degree of ethoxylation is about 5.

15. The adjuvant of claim 13, wherein the mixture is comprised of about 40% to 60% by weight of glycerol and about 10% to 20% of a polyhydric alcohol mixture.

16. A pesticidal composition exhibiting reduced eye irritation, fish toxicity, and increased compatibility with other adjuvants and/or pesticides comprising:
(a) polyoxyalkylene aliphatic amine where the ratio of active pesticide to polyoxyalkylene aliphatic amine surfactant is in a range of 10:1 to 100:1; and
(b) a mixture glycerol and
(c) optionally at least one polyhydric alcohol; and
(d) a pesticide.

17. The pesticidal composition of claim 16, wherein the polyoxyalkylene aliphatic amine is ethoxylated tallow amine having an average degree of ethoxylation of from about 2 to about 50.

18. The pesticidal composition of claim 16, wherein the average degree of ethoxylation is about 5.

19. The pesticidal composition of claim 16, wherein a mixture of polyhydric alcohols is present containing at least two of ethylene glycol, diethylene glycol and propylene glycol.

20. A method of killing or controlling weeds comprising contacting the weeds with a herbicidally effective amount of the composition of claim 16.

21. A pesticide formulation comprising a pesticide, water and at least one amine ethoxylate and at least one glycerol source.

22. A method for enhancing the compatibility in the spray tank with more than one pesticide and/or adjuvant, while maintaining pesticidal performance characteristics of a primary agrochemical comprising:
introducing into a spray tank containing said primary agrochemical an adjuvant composition containing:
(a) at least one amine ethoxylate and
(b) at least one glycerol to form a pesticidal composition.

23. A method of killing or controlling weeds comprising applying to said weeds a herbicidally effective amount of the pesticidal composition prepared by the method of claim 22.
